(19) United States
(12) Patent Application Publication
(10) Pub. No.: US 2002/0195731 A1
(43) Pub. Date: Dec. 26, 2002

(54) Disk substrate peeling unit and disk manufacturing method

(75) Inventor: Keiji Suga, Tsurugashima-shi (JP)

Correspondence Address: SUGHRUE MION, PLLC, 2100 PENNSYLVANIA AVENUE, N.W., WASHINGTON, DC, 20037, US

(73) Assignee: PIONEER CORPORATION

(21) Appl. No.: 10/170,348

(22) Filed: Jun. 14, 2002

(30) Foreign Application Priority Data
Jun. 21, 2001 (JP) P2001-188247

(51) Int. Cl. B29D 11/00; B29C 45/42

(52) U.S. Cl. 264/1.33; 425/556; 425/436 RM

(57) ABSTRACT

A disk substrate peeling unit for peeling an injection-molded disk substrate from a die, is provide with: a sticking body that sticks to one face of the disk substrate and is integrated with the disk substrate in the case of peeling the disk substrate from the die; and a robot arm that supports the sticking body.

### BACKGROUND OF THE INVENTION

1. Field of the invention

The present invention relates to a disk molding apparatus for molding substrates of disks, such as compact disks (CDs) and digital versatile disks (DVDs), and more particularly to a disk substrate peeling unit permitting strain-free peeling of a molded disk substrate.

2. Description of the Related Art

According to the prior art, in a disk molding apparatus for molding disk substrates by injection molding, molten resin material consisting of polycarbonate or the like is injected and fills a cavity formed by a fixed die and a movable die provided in the apparatus, and concaves and convexes that are cut as signal pits on a stamper fitted to the apparatus are transferred to the molten resin material to mold a disk substrate. After that, the central part of the molded disk substrate is punched with a cut punch provided in the apparatus and, after cooling, the dies are opened to peel off the disk substrate stuck to the stamper over the movable die with an air blower and a mechanical ejector.

FIG. 6 shows how a disk substrate is peeled. As illustrated in FIG. 6, a disk substrate 54 stuck to a stamper 53 fitted onto a movable die 57 with stamper keep pieces is vacuum-sucked by suction pads 55a of a disk substrate peeling unit 55 (e.g. the part of the inner circumference of no more than 40 mm in diameter, where no signal pit is formed, is sucked), and peeled while being held. When the disk substrate 54 is peeled, an extruding ejector 58 provided in the movable die 57 is thrust out, and the disk substrate 54 is extruded by the extruding ejector 58.

After that, the pit forming face (signal face) of the disk substrate 54 is coated with aluminum by sputtering or vacuum vapor deposition to form a reflective layer, and the surface of this reflective layer is spin-coated with ultraviolet-setting resin or the like, the coat being irradiated with ultraviolet rays to form a protective layer.

However, this disk substrate peeling method for the conventional disk molding apparatus, as it involves suction and peeling of a prescribed part, for instance the part of the inner circumference of no more than 40 mm in diameter where no signal pit is formed, involves the inconvenience that cracks easily occur in the disk substrate. Moreover, there is another inconvenience that, at the time of peeling, the disk substrate is distorted to invite warping, pit deformation or the like.

This inconvenience will become even more conspicuous in the future when thin disk substrates of 0.3 mm or less in thickness are to be molded and peeled with the above described method (e.g. in the case of DVDs currently in use, the disk substrate is 0.6 mm thick). Moreover, the conventional disk molding apparatus involves the inconvenience that, where thin disk substrates of 0.3 mm or less in thickness are molded with it, the disk substrates are insufficient in rigidity and accordingly susceptible to warping or the like, which would adversely affect the subsequent formation of the reflective layer and the protective layer.

### SUMMARY OF THE INVENTION

It is therefore an object of the present invention to provide a disk substrate peeling unit and a disk manufacturing method capable of preventing the occurrence of cracking, warping, pit deformation or the like at the time of disk substrate peeling, and permitting more smooth progress of the disk manufacturing process after the disk substrate is peeled.

The above object of the present invention can be achieved by a disk substrate peeling unit for peeling an injection-molded disk substrate from a die, provided with: a sticking body that sticks to one face of the disk substrate and is integrated with the disk substrate in the case of peeling the disk substrate from the die; and a robot arm that supports the sticking body.

According to the present invention, the disk substrate can be peeled without allowing any crack or distortion to occur, it becomes possible to eliminate effects to invite warping of the disk or pit deformation. As even a thin disk substrate of 0.3 mm or less in thickness can be peeled, with the rigidity of the disk substrate reinforced by the sticking body, warping and other troubles can be prevented.

In one aspect of the disk substrate peeling unit of the present invention, the sticking body covers virtually the whole area of the face of the disk substrate and is integrated with the disk substrate by interfacial suction.

According to this aspect, if the interfacial suction is accomplished by vacuum suction for instance, not only the sticking body and the disk substrate can be integrated easily but also they can be released from the integration easily, resulting in a smoother shift to subsequent processes (e.g. reflective layer and protective layer formation processes).

In another aspect of the disk substrate peeling unit of the present invention, one or a plurality of annular suction grooves for interfacially sucking the disk substrate are provided in one face of the sticking body to be stuck to the disk substrate.

According to this aspect, the sticking body can be stuck to and integrated with the disk substrate with no strain by interfacial suction.

In further aspect of the disk substrate peeling unit of the present invention, the sticking body covers virtually the whole area of the face of the disk substrate and is adhered to and integrated with the disk substrate.

According to this aspect, the sticking body and the disk substrate are integrated by adhesion with an adhesive for instance and released from the integration easily by thermal peeling or ultraviolet peeling, resulting in a smoother shift to subsequent processes (e.g. the reflective layer and protective layer formation processes).

In further aspect of the disk substrate peeling unit of the present invention, a shape and dimension of one face of the sticking body to be stuck to the disk substrate are substantially the same as a shape and dimension, respectively, of the face of the disk substrate.

According to this aspect, the sticking body can be stuck to and integrated with the disk substrate with no strain.

In still further aspect of the disk substrate peeling unit of the present invention, the sticking body is detachable from the robot arm.

According to this aspect, as the disk substrate and the sticking body, being kept integrated with each other, i.e. with the sticking body kept stuck to the disk substrate as a reinforcing member of the latter, to be shifted to the following processes (e.g. the reflective layer and protective layer formation processes), warping and other troubles can be prevented even if the disk substrate is very thin, 0.3 mm or even less in thickness.

The above object of the present invention can be achieved by a disk manufacturing method of manufacturing a disk by injection molding, provided with: a process of peeling an injection-molded disk substrate from a die after sticking a sticking body supported by a robot arm to one face of the disk substrate and integrating the sticking body with the disk substrate; a process of disengaging the sticking body from the robot arm with the peeled disk substrate kept being integrated with the sticking body; and a process of forming, after forming a reflective layer on a signal pit formation face of the disk substrate integrated with the sticking body, a protective layer over the reflective layer.

According to the present invention, as the reflective layer and protective layer processes can be carried out with the disk substrate and the sticking being kept integrated with each other, i.e. with the sticking body kept stuck to the disk substrate as a reinforcing member of the latter, warping and other troubles can be prevented even if the disk substrate is very thin, 0.3 mm or even less in thickness.

### BRIEF DESCRIPTION OF THE DRAWINGS

FIG. 1 shows a typical section of an essential part of a disk molding apparatus;

FIG. 2A shows a sticking body 31 of a disk substrate peeling unit 3 as viewed in a direction of an arrow “X” in FIG. 1;

FIG. 2B, the sticking body 31 of a disk substrate peeling unit 3 as viewed in a direction of an arrow “Y” in FIG. 1;

FIG. 3 shows how the disk substrate peeling unit 3 moves;

FIG. 4 is a flow chart of a disk manufacturing process;

FIGS. 5A to 5C show the disk substrate at each processes (steps) of the disk manufacturing process; and

FIG. 6 shows how a disk substrate is peeled in the conventional disk molding apparatus.

### DETAILED DESCRIPTION OF THE PREFERRED EMBODIMENTS

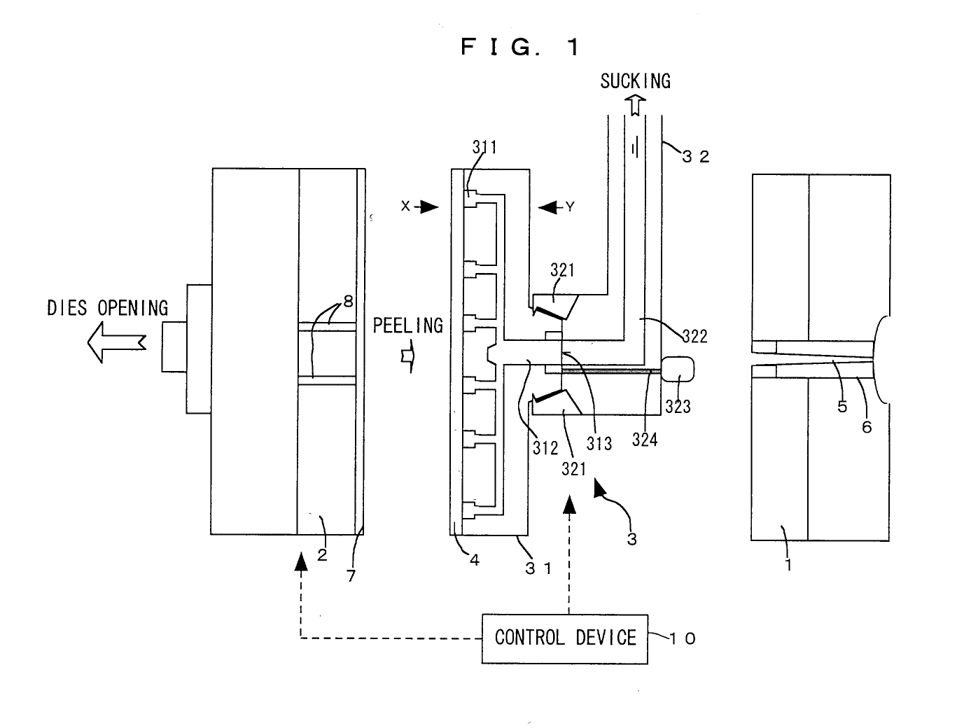

Preferred embodiments of the present invention will be described in detail below with reference to accompanying drawings. FIG. 1 shows a typical section of an essential part of a disk molding apparatus, specifically how a disk substrate (e.g. an optical disk substrate) is peeled.

A disk molding apparatus is provided with a fixed die 1, a movable die 2, a disk substrate peeling unit 3, a unit drive section for driving the disk substrate peeling unit 3, control device 10 for controlling these elements. In a state in which the dies are closed when a disk substrate is molded, the disk substrate peeling unit 3 is not positioned between the fixed die 1 and the movable die 2, but a cavity for molding a disk substrate 4 is formed between the fixed die 1 and the movable die 2.

A sprue 5 for injecting molten resin material (e.g. polycarbonate) into the cavity is built into a central part of the fixed die 1 via a sprue bush 6. On the other hand, a cut punch for punching the central part of the molded disk and forming a hole is slidably provided in the central part of the movable die 2. A stamper 7 for transferring and molding signal pits of the disk is fixed with stamper keep pieces on the cavity side of the movable die 2. Further, the movable die 2 is provided with an extruding ejector 8 for thrusting out the disk substrate 4 when it is to be peeled.

The disk substrate peeling unit 3 is provided with a sticking body 31 for sticking to one face of the disk substrate 4 and becoming integrated with the disk substrate 4 in the case of peeling the disk substrate 4 from the movable die 2, and a robot arm 32 for supporting the sticking body 31. The disk substrate peeling unit 3, after the disk substrate 4 is molded within the cavity and the dies are opened, is brought by a unit drive section between the fixed die 1 and the movable die 2 to suck and peel the disk substrate 4 stuck to the stamper 7.

The sticking body 31 is detachably connected with the robot arm 32 by hooks 321 of the robot arm 32. Within the sticking body 31, there are provided vacuum sucking holes 311 for sucking the disk substrate 4 and a vacuum sucking duct 312, which is the passage of vacuum, so that the sticking body 31 as a whole can function as a suction pad for sucking the disk substrate 4.

On the other hand, within the robot arm 32 as well, there is provided a vacuum sucking duct 322. The vacuum sucking duct 312 of the sticking body 31 and the vacuum sucking duct 322 of the robot arm 32 link with each other via a junction face 313. The junction face 313 of the sticking body 31 is provided with a shutter, to be described in more detail afterwards, for cutting off the link between the vacuum sucking duct 312 and the vacuum sucking duct 322 with each other.

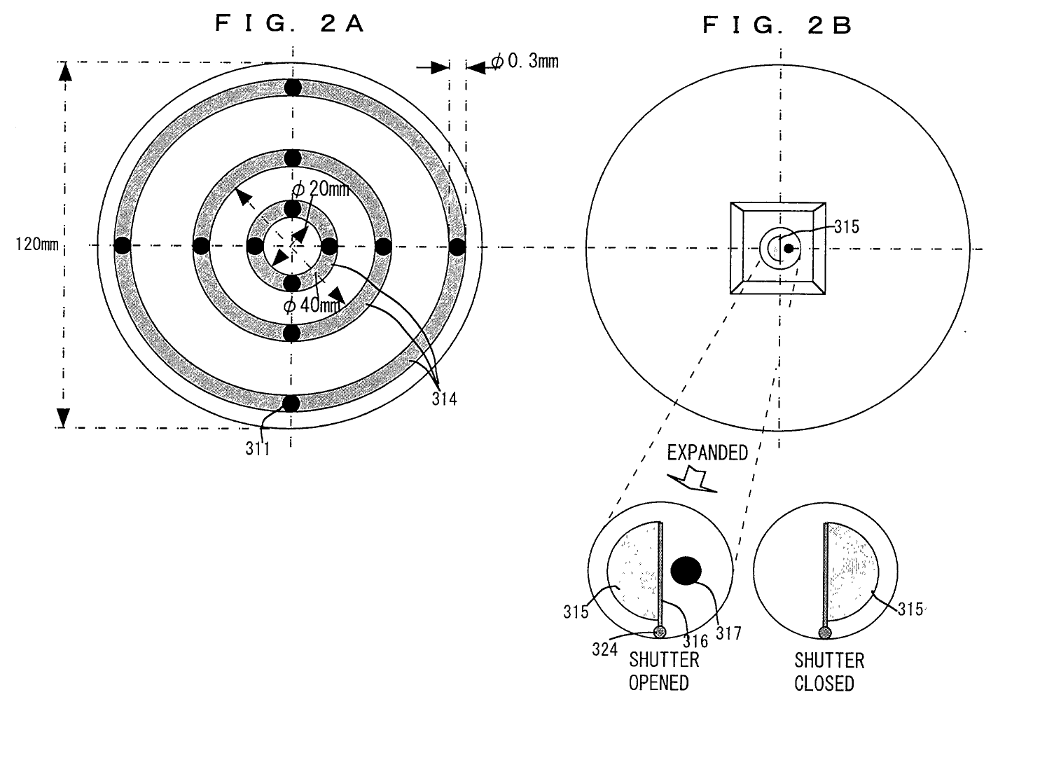

FIG. 2A shows the sticking body 31 of the disk substrate peeling unit 3 as viewed in the direction of an arrow “X” in FIG. 1, and FIG. 2B shows the sticking body 31 of the disk substrate peeling unit 3 as viewed in the direction of an arrow “Y” in FIG. 1. As illustrated in FIG. 2A, the shape and dimensions of one face in which the sticking body 31 sticks to the disk substrate are substantially the same as the shape and dimensions, respectively, of the face of the disk substrate 4. Thus, the sticking body 31 covers substantially the whole of the face of the disk substrate 4 and, at the same time, sucks and is integrated with the disk substrate 4 by interfacial suction.

Then the disk substrate 4, in a state in which it is integrated with the sticking body 31, is vertically peeled from the stamper 7. Therefore, the disk substrate can be peeled without allowing any crack or distortion to occur, it becomes possible to eliminate effects to invite warping of the disk or pit deformation. Since even a thin disk substrate of 0.3 mm or less in thickness can be peeled, with the rigidity of the disk substrate reinforced by the sticking body 31, warping and other troubles can be prevented.

In the example shown in FIG. 2A, twelve vacuum sucking holes 311 are provided in a cross form, and they are accommodated in annular vacuum suction grooves 314 cut in a prescribed depth. Thus, the disk substrate 4 is sucked by all these vacuum suction grooves 314. Therefore, it becomes possible to stick the sticking body 31 to the disk substrate 4 with no strain by interfacial suction and integrate them.

To add, although a total 12 vacuum sucking holes 311 are provided in a cross form in the example shown in FIG. 2A, their number is not limited to 12, but can be either more or less if sufficient to securely suck the disk substrate 4. Also, though three annular vacuum suction grooves 314 are provided in the example of FIG. 2A, their number is not limited to three, but can be either more or less if sufficient to securely suck the disk substrate 4.

Further, as shown in FIG. 2B, the junction face 313 of the sticking body 31 of the disk substrate peeling unit 3 with the robot arm 32 is provided with a shutter 315 and a vacuum linking hole 317. This vacuum linking hole 317 is the only linking hole for the vacuum between the vacuum sucking duct 312 of the sticking body 31 and the vacuum sucking duct 322 of the robot arm 32, and the vacuum is linked when the shutter 315 is “open” as shown in FIG. 2B.

On the other hand, when the shutter 315 is “closed”, the vacuum linking hole 317 is blocked by the shutter 315 and the link between the vacuum sucking duct 312 and the vacuum sucking duct 322 is cut off as shown in FIG. 2B. In this state, as the pressure in the vacuum sucking duct 312 of the sticking body 31 is kept at the same level as during the vacuum suction before the shutter 315 is closed, the suction of the disk substrate 4 is maintained as it is.

These opening and closing actions of the shutter 315 are accomplished by the rotation of a shutter shaft 316 provided for the shutter 315. The shutter shaft 316 rotates correspondingly to the rotation of a rotation shaft 324 turned by a motor 323 (see FIG. 1) fitted to the robot arm 32 and in a direction corresponding to the turning direction of the rotation shaft 324. The motor 323 is driven by the control device 10.

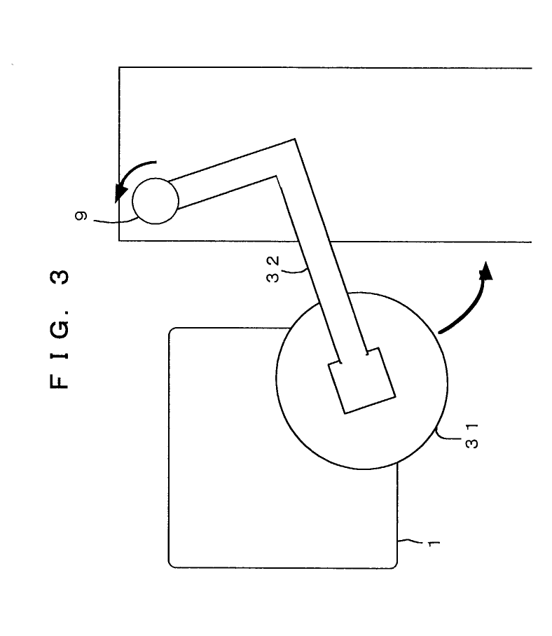

FIG. 3 shows how such a disk substrate peeling unit 3 operates. After having sucked and peeled the disk substrate 4, the disk substrate peeling unit 3, as shown in FIG. 3, is rotationally shifted by a unit drive section 9 in the direction of the arrows to feed the disk substrate 4 to the next process. In this process, in the disk substrate peeling unit 3, the shutter 315 is closed to disengage the sticking body 31 from the hooks 321 of the robot arm 32. Thus, the disk substrate 4 is integrated with the sticking body 31 when it is fed to the next process. As this enables the disk substrate 4 and the sticking body 31, being kept integrated with each other, i.e. with the sticking body 31 kept stuck to the disk substrate 4 as a reinforcing member of the latter, to be shifted to the following processes (e.g. the reflective layer and protective layer formation processes), warping and other troubles can be prevented even if the disk substrate is very thin, 0.3 mm or even less in thickness.

Incidentally, it is also conceivable to disengage the disk substrate 4 from the sticking body 31 and feed only the disk substrate 4 to the next process.

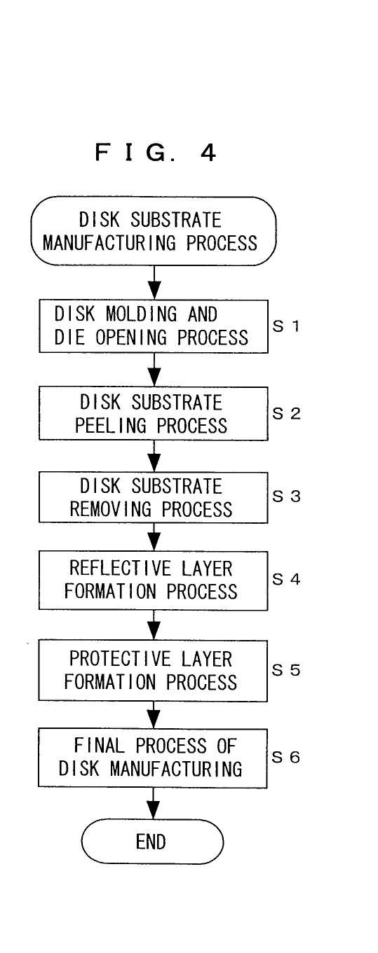

Next will be described the rest of the disk manufacturing process from the peeling of the disk substrate 4 until the completion of the disk. FIG. 4 is a flow chart of the disk manufacturing process.

First at the disk molding and die opening process (S1), the disk substrate 4 is molded in the cavity formed by the fixed die 1 and the movable die 2, and the dies are opened.

Next, at the disk substrate peeling process (S2), the disk substrate peeling unit 3, driven by the unit drive section 9, is brought between the fixed die 1 and the movable die 2. Then, the disk substrate peeling unit 3 shifts toward the disk substrate 4, and the sticking body 31 is adhered to the disk substrate 4. After that, the disk substrate 4 is vacuum-sucked through the vacuum sucking duct 322, the vacuum linking hole 317, the vacuum sucking duct 312 and the vacuum sucking holes 311 of the disk substrate peeling unit 3. Then, air for peeling the disk substrate 4 is blown from an air flow outlet, the extruding ejector 8 for thrusting out the disk substrate 4 is protruded, and the disk substrate peeling unit 3, driven by the unit drive section 9, peels the disk substrate 4 from the stamper 7. Thus, the disk substrate 4 is peeled over its whole surface.

Next, at the disk substrate removing step (S3), the motor 323 is so controlled as to close the shutter 315 of the sticking body 31 for the substrate peeling unit 3. Although this causes the vacuum linking hole 317 of the sticking body 31 to be blocked, the disk substrate 4 is kept sucked because the pressure in the vacuum sucking duct 312 is maintained constant. Then the disk substrate 4, kept sucked by the sticking body 31, is fed to the following reflective layer forming process by the substrate peeling unit 3.

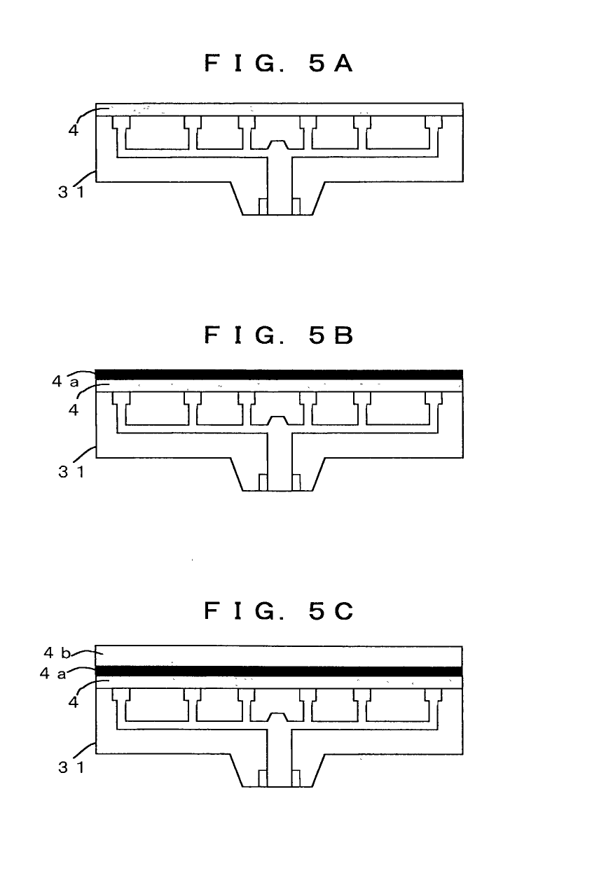

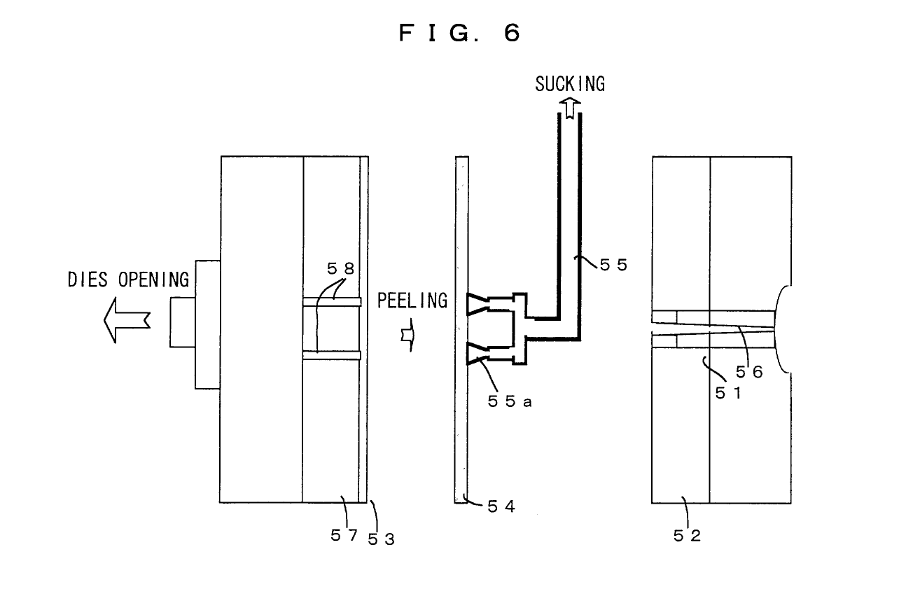

That is, in the substrate peeling unit 3, the sticking body 31 is disengaged from the hooks 321 and, as shown in FIG. 5A, the sticking body 31 and the disk substrate 4, integrated with each other, are fed to the reflective layer formation process. This shifting of the disk substrate 4 and the sticking body 31, kept integrated with each other, i.e. with the sticking body 31 kept stuck to the disk substrate 4 as a reinforcing member of the latter, to the reflective layer and protective layer formation processes can make the progress of the whole disk manufacturing process smoother.

Next, at the reflective layer formation process (S4), the pit forming face (signal face) of the disk substrate 4 is coated with metal, such as aluminum or aluminum alloy, by RF sputtering or vacuum vapor deposition to form a reflective layer 4a as shown in FIG. 5B, and the disk substrate 4 is fed to the protective layer formation process.

Then, at the protective layer formation process (S5), the reflective layer of the disk substrate 4 is overcoated with ultraviolet-setting resin, for instance, and the coat is hardened by irradiation with ultraviolet rays to form a protective layer 4b as shown in FIG. 5C. The disk substrate 4 is then fed to the final process of the disk manufacturing process.

Next at the final process of the disk manufacturing process (S6), if signals are recorded on only one side of the disk (e.g. CD), the sticking body 31 is peeled from the disk substrate 4 by opening the shutter 315 of the sticking body 31 after a label or the like is printed on the surface of the protective layer 4b to equalize the pressure in the vacuum sucking duct 312 of the sticking body 31 with the atmospheric pressure, and the disk is now completed.

Or, where signals are to be recorded on both sides of the disk (e.g. DVD), an adhesive is applied in a doughnut shape to the protective layer 4b of one disk substrate 4 near its center, and another disk substrate 4 to be glued together with the first one is placed, with its protective layer 4b opposite, over this adhesive-applied surface of the first optical disk substrate 4. Then the adhesive is hardened by irradiation with ultraviolet rays. Then, the shutter 315 of the sticking body 31 of each of the two disk substrates 4 is opened to equalize the pressure in the vacuum sucking duct 312 of the sticking body 31 with the atmospheric pressure, and the disk substrates 4 are peeled from the sticking body 31 to complete the disk.

As described above, when the disk substrate 4 is peeled from the stamper 7, since the sticking body 31 of the disk substrate peeling unit 3 is stuck to one face of and integrated with the disk substrate 4, the disk substrate 4 can be peeled without allowing any crack or distortion to occur, it becomes possible to eliminate effects to invite warping of the disk or pit deformation. Since even a thin disk substrate 4 of 0.3 mm or less in thickness can be peeled, with the rigidity of the disk substrate 4 reinforced by the sticking body, warping and other troubles can be prevented.

Also, as the disk substrate 4 and the sticking body 31, being kept integrated with each other, are shifted to the following processes (e.g. the reflective layer and protective layer formation processes), warping and other troubles can be prevented even if the disk substrate 4 is very thin, 0.3 mm or even less in thickness.

To add, although in this embodiment the sticking body 31 and the disk substrate 4 are vacuum-sucked to each other as an example of configuration in which the sticking body 31 is stuck to one face of the disk substrate 4, the configuration is not limited to this, but it is also conceivable, for instance, that the sticking body 31 covers virtually the whole area of one face of the disk substrate 4 and is integrated with the disk substrate 4 by adhesion (e.g. with an adhesive). In this case, as its release can be easily accomplished by thermal peeling or ultraviolet ray peeling, smooth progress to the following processes (e.g. the reflective layer and protective layer formation processes) is possible as in the case of vacuum sucking. Electrostatic adhesion by electrostatic chucking or the like is also possible. A porous sheet or porous ceramic can as well be used as the material for the sticking body for vacuum sucking.

Although in this embodiment the sticking body 31 is stuck onto the other face of the disk substrate 4 than its signal recording face, the sticking body 31 can as well be stuck to the signal recording face and integrated with the disk substrate 4. In this case, the annular vacuum suction grooves 314 shown in FIG. 2A are provided elsewhere than the area in which signal pits are formed on the disk substrate 4, for instance the innermost and outermost areas.

While in this embodiment the sticking body 31 is configured to be detachably connected with the robot arm 32 with the hooks 321 of the robot arm 32, the configuration is not limited to this. For instance, the sticking body 31 and the robot arm 32 can as well be connected with and removed from each other with an electromagnet.

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description and all changes which come within the meaning and range of equivalency of the claims are therefore intended to be embraced therein.

The entire disclosure of Japanese Patent Application No. 2001-188247 filed on Jun. 21, 2001 including the specification, claims, drawings and summary is incorporated herein by reference in its entirety.

What is claimed is:

1. A disk substrate peeling unit for peeling an injection-molded disk substrate from a die, comprising:
a sticking body that sticks to one face of the disk substrate and is integrated with the disk substrate in the case of peeling the disk substrate from the die; and
a robot arm that supports the sticking body.

2. The disk substrate peeling unit according to claim 1,
wherein the sticking body covers virtually the whole area of the face of the disk substrate and is integrated with the disk substrate by interfacial suction.

3. The disk substrate peeling unit according to claim 2,
wherein one or a plurality of annular suction grooves for interfacially sucking the disk substrate are provided in one face of the sticking body to be stuck to the disk substrate.

4. The disk substrate peeling unit according to claim 1,
wherein the sticking body covers virtually the whole area of the face of the disk substrate and is adhered to and integrated with the disk substrate.

5. The disk substrate peeling unit according to claim 1,
wherein a shape and dimension of one face of the sticking body to be stuck to the disk substrate are substantially the same as a shape and dimension, respectively, of the face of the disk substrate.

6. The disk substrate peeling unit according to claim 1,
wherein the sticking body is detachable from the robot arm.

7. A disk manufacturing method of manufacturing a disk by injection molding, comprising:
a process of peeling an injection-molded disk substrate from a die after sticking a sticking body supported by a robot arm to one face of the disk substrate and integrating the sticking body with the disk substrate;
a process of disengaging the sticking body from the robot arm with the peeled disk substrate kept being integrated with the sticking body; and
a process of forming, after forming a reflective layer on a signal pit formation face of the disk substrate integrated with the sticking body, a protective layer over the reflective layer.
